(19) United States
(12) Patent Application Publication
(10) Pub. No.: US 2007/0140478 A1
(43) Pub. Date: Jun. 21, 2007

(54) Encryption apparatus and encryption method

(76) Inventors: Yuichi Komano, Kawasaki-shi (JP); Hideo Shimizu, Kawasaki-shi (JP); Atsushi Shimbo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/523,609

(22) Filed: Sep. 20, 2006

(30) Foreign Application Priority Data
Dec. 15, 2005 (JP) 2005-361996
Aug. 8, 2006 (JP) 2006-215447

(51) Int. Cl. H04L 9/28

(52) U.S. Cl. 380/28

(57) ABSTRACT

An encryption apparatus for generating a ciphertext block from a plaintext block is disclosed. A selector selects at random one mask random number from a plurality of random numbers generated by a random number generator. A mask processing unit executes mask processing of a plaintext block by using the mask random number selected by the selector. A storage unit stores a first table representing an initial S-box. A converter converts the first table into a second table representing a deformed S-box on the basis of the mask random number selected by the selector. An encryption unit generates a ciphertext block by shuffling the mask-processed plaintext block using the second table.

### CROSS-REFERENCE TO RELATED APPLICATIONS

This application is based upon and claims the benefit of priority from prior Japanese Patent Applications No. 2005-361996, filed Dec. 15, 2005; and No. 2006-215447, filed Aug. 8, 2006, the entire contents of both of which are incorporated herein by reference.

### BACKGROUND OF THE INVENTION

1. Field of the Invention

The present invention relates to an encryption apparatus, encryption method, and encryption program using private key block encryption that is secure against power analysis.

2. Description of the Related Art

Data encryption standard (DES) is private key block encryption that is widely used for the purpose of concealing, e.g., communication contents (e.g., JP-A 51-108701 (KOKAI).

Recently, Paul Kocher et al. have proposed differential power analysis (DPA). DPA is an analyzing method which estimates key information secretly held by an encryption apparatus by analyzing, using a statistical technique, power traces consumed by the encryption apparatus in encrypting a plurality of plaintext blocks (e.g., Paul Kocher, Joshua Jaffe, and Benjamin Jun, “Differential Power Analysis” in Proceedings of Advances in Cryptology—CRYPTO '99 Springer-Verlag, 1999).

As a known countermeasure against DPA, a plaintext block is mask-processed by using a random number to make intermediate data processed in an encryption apparatus unpredictable for the analyzer, thereby invalidating statistical analysis. However, Paul Kocher et al. have reported higher-order DPA in which key information secretly held by the encryption apparatus is estimated by invalidating the random number masking measure by using power consumption values observed at a plurality of timings. It is known that the key information secretly held by the encryption apparatus can be estimated by higher-order DPA using the timing of mask random number generation in the encryption apparatus and the timing of nonlinear operation of encryption processing.

Ito et al. have devised an arrangement of an encryption apparatus which ensures security against DPA by selecting, at random in every encryption processing, a plurality of conversion tables corresponding to a plurality of mask values fixed in advance (e.g., JP-A No. 2002-366029 (KOKAI)). In the encryption apparatus of Ito et al., when a plaintext block is input from the outside, a random number generator generates a random number for mask selection. In accordance with the mask selection random number, a selection unit selects a mask value and a conversion table corresponding to it from a plurality of mask values and conversion tables stored in advance in a mask storage unit and a table storage unit, respectively. A mask processing unit executes mask processing of the received plaintext block by using the selected mask value. The plaintext block which has undergone the mask processing is converted into a ciphertext block depending on key information by using the selected conversion table.

The method proposed by Ito et al. can invalidate the above-described higher-order DPA using two timings because no mask random number is generated.

It is however known that the key can be estimated by DPA or higher-order DPA if the bits (0 and 1) of the mask value are ill-balanced. To prevent this, well-balanced mask values must be prepared in advance. In addition, if the mask values fixed in advance are revealed by, e.g., reverse engineering, the key information may be estimated on the basis of slight imbalance.

### BRIEF SUMMARY OF THE INVENTION

According to an aspect of the present invention, there is provided an encryption apparatus for generating a ciphertext block from a plaintext block, comprising a random number generator which generates a plurality of random numbers, a selector which selects one mask random number from the plurality of random numbers at random, a mask processing unit which executes mask processing of a plaintext block by using the mask random number selected by the selector, a storage unit which stores a first table representing an initial S-box, a converter which converts the first table into a second table representing a deformed S-box on the basis of the mask random number selected by the selector, and an encryption unit which generates a ciphertext block by shuffling the mask-processed plaintext block using the second table.

### BRIEF DESCRIPTION OF THE SEVERAL VIEWS OF THE DRAWING

FIG. 1 is a block diagram showing an encryption algorithm DES;

FIG. 2 is a circuit diagram showing a round function in detail;

FIG. 3 is a view showing an example of an S-box (S1) table;

FIG. 4 is a block diagram showing an encryption apparatus according to the first embodiment;

FIG. 5 is a detailed block diagram showing the encryption apparatus according to the first embodiment;

FIG. 6 is a block diagram showing an encryption apparatus according to the second embodiment;

FIG. 7 is a detailed block diagram showing the encryption apparatus according to the second embodiment;

FIG. 8 is a block diagram showing an encryption apparatus according to the third embodiment;

FIG. 9 is a detailed block diagram showing the encryption apparatus according to the third embodiment;

FIG. 10 is a view showing an encryption algorithm AES;

FIG. 11 is a block diagram showing an encryption apparatus according to the fourth embodiment; and

FIG. 12 is a detailed block diagram showing the encryption apparatus according to the fourth.

### DETAILED DESCRIPTION OF THE INVENTION

Embodiments in which the present invention is applied to data encryption standard (DES) will be described below.

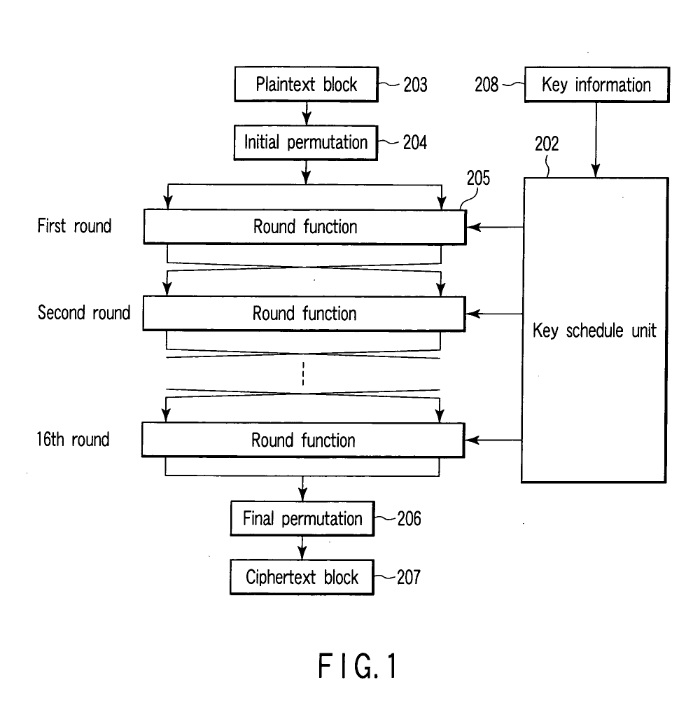

Referring to FIG. 1, a plaintext block (64 bits) 203 is shuffled using an expansion key 208 calculated by a key schedule unit 202 from the key information 208 secretly held in an encryption apparatus. In this way, a ciphertext block 207 is calculated. More specifically, the plaintext block 203 is subjected to initial permutation 204 and divided into 32-bit data on the left (upper) side and 32-bit data on the right (lower) side. The divided 32-bit data on the left side and 32-bit data on the right side are input to a round function 205 (to be described later). The 32-bit data on the left side and that on the right side are interchanged, output from the round function 205, and input to the next round function. Such a round function is repeated 16 times. Final permutation 206 is executed for the result. The encryption processing is thus ended, and the ciphertext block 207 is obtained.

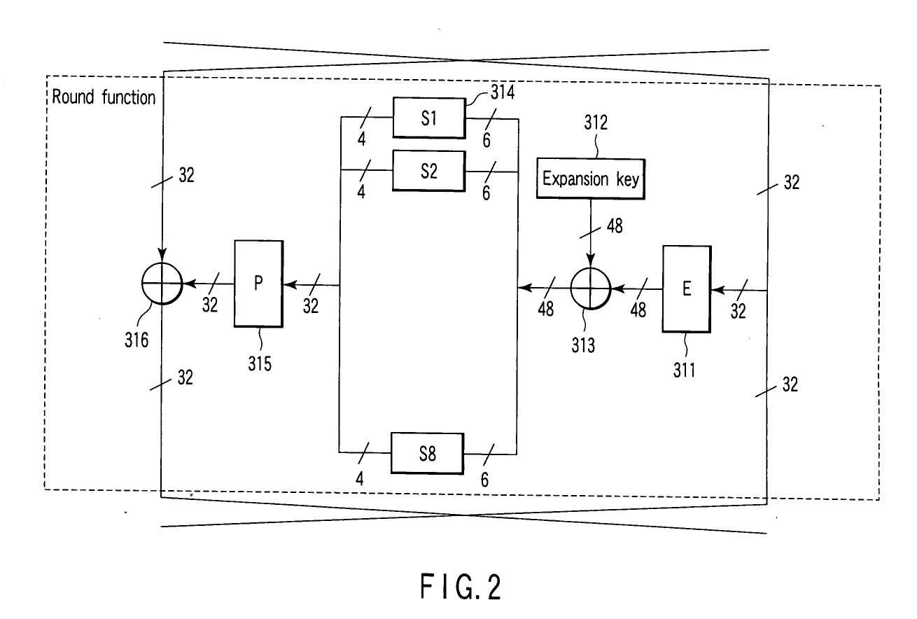

As shown in FIG. 2, a round function 317 includes an expansion permutation E 311, exclusive OR 313, a plurality of S-boxes (S1, S2, . . . , S8), permutation P 315, and exclusive OR 316.

The 32-bit data on the right side is expanded to 48-bit data by the expansion permutation E 311. The result is output to the exclusive OR 313. The exclusive OR 313 outputs the exclusive OR between an expansion key 312 and the output from the expansion permutation E 311. The 48-bit data output from the exclusive OR 313 is equally divided into 6-bit data and input to the S-boxes.

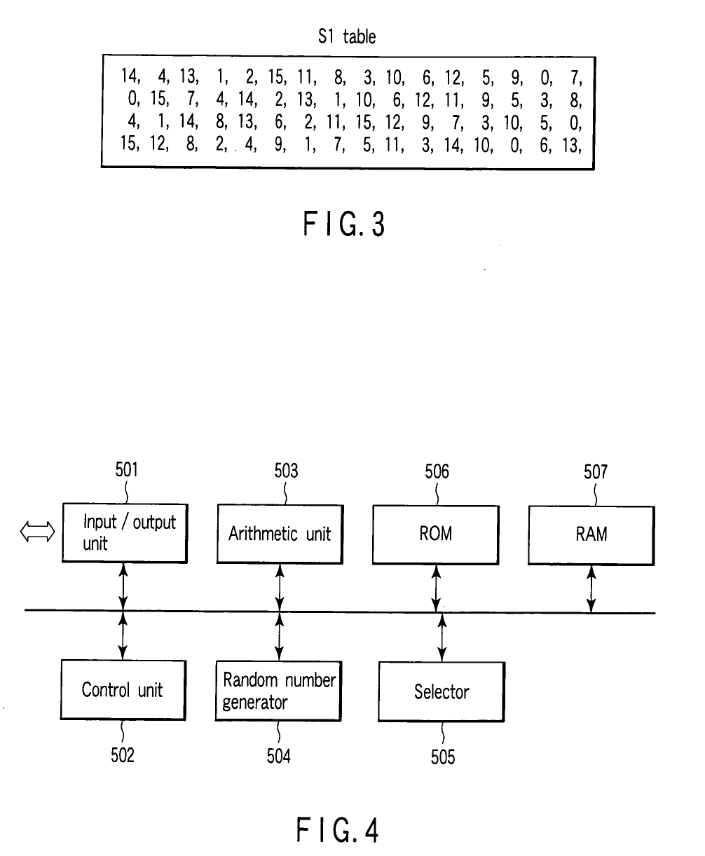

Each S-box includes a table and outputs 4-bit data in correspondence with each of 64 entries of 6-bit input. In, e.g., an S-box (S) 314, the left end of the 6-bit input is defined as the first bit, and the right end is defined as the sixth bit. A row of the S-box table (S1 table) shown in FIG. 3 is designated by the first and sixth bits regarded as a binary number. The rows of the S1 table shown in FIG. 3 are defined as the 0th, 1st, 2nd, and 3rd rows from the upper side. Next, a column number is designated by the four remaining bits regarded as a binary number. The columns are defined as the 0th, 1st, 2nd, 3rd, . . . , and 15th columns from the left end. For example, assume that the input to S1 is 011011. Then, the row number is 01, i.e., indicates the second row from the upper side in FIG. 3. The column number is 1101, i.e., 13 (the 14th column from the left end). Hence, the value in the tale is 5. The output from S1 is the binary expression of 5, i.e., 0101. In FIG. 3, the output from the S-box is defined by a row and a column. Generally, the S-box is formed as a table corresponding to inputs of 0 to 63. Thirty-two-bit data obtained by combining the outputs of the S-boxes is subjected to bit transposition by the permutation P 315. The result is output to the exclusive OR 316. The exclusive OR 316 outputs the exclusive OR between the 32-bit data on the left side and the output from the permutation P 315.

### FIRST EMBODIMENT

Referring to FIG. 4, the encryption apparatus according to the first embodiment includes an input/output unit 501, control unit 502, arithmetic unit 503, random number generator 504, selector 505, read only memory (ROM) 506, and random access memory (RAM) 507.

The input/output unit 501 receives, as an input, a plaintext block (64 bits) from the outside and outputs a ciphertext block (64 bits) as a calculation result. The control unit 502 generates a clock signal and controls the operation of the encryption apparatus. The arithmetic unit 503 executes arithmetic processing such as addition and exclusive OR in accordance with an input (instruction and data). The random number generator 504 generates mask random numbers and a selection random number. On the basis of the selection random number generated by the random number generator 504, the selector 505 selects one of a plurality of mask random numbers generated by the random number generator 504 and one of a plurality of S-boxes deformed in correspondence with the mask random number. The ROM 506 stores instruction codes, initial permutation, expansion permutation, S-boxes, permutation using round functions, final permutation, key information, and information necessary for key schedule. The RAM 507 is a memory to save random numbers generated by the random number generator 504, deformed S-boxes, and data obtained in a calculation process.

Mehdi-Laurent Akkar et al. have proposed a method of preparing S-boxes corresponding to different mask random numbers in rounds to improve the security of an encryption apparatus (e.g., Mehdi-Laurent Akkar, Reigis Bevan, and Louis Goubin, “Two Power Analysis Attacks against One-Mask Methods”, Fast Software Encryption 2004, Springer-Verlag, 2004). In the first embodiment, the security can further be improved by using the method of Mehdi-Laurent Akkar et al., though a description thereof will be omitted.

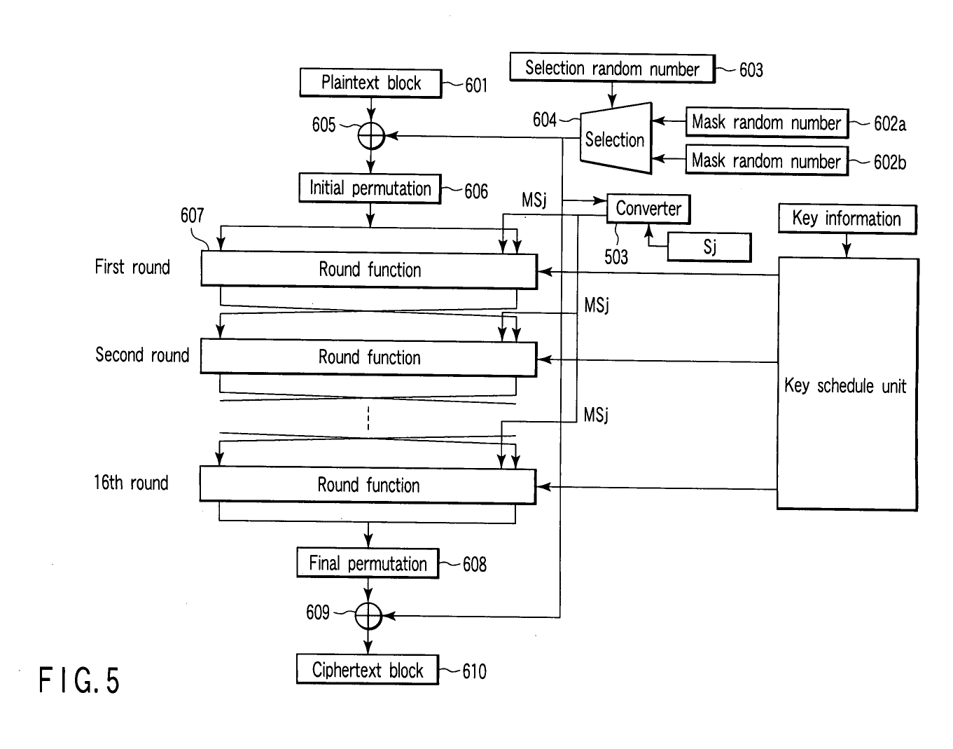

The operation of the encryption apparatus according to the first embodiment will be described with reference to FIG. 5.

When the input/output unit 501 receives a plaintext block (64 bits) 601, the random number generator 504 generates mask random numbers 602a and 602b (each contains 64 bits) and a selection random number 603 (one bit). The selector 505 executes selection processing 604 of one of the mask random numbers 602a and 602b on the basis of the selection random number 603.

Assume that the mask random number 602a is selected by the selection processing 604. The arithmetic unit (converter) 503 converts S-boxes stored in the ROM 506 into deformed S-boxes on the basis of the mask random number 602a. More specifically, the mask random number 602a is subjected to initial permutation and divided into 32-bit data on the left (upper) side and 32-bit data on the right (lower) side. The 32-bit data on the right side is expanded to 48-bit data by expansion permutation of a round function and divided into mi1, mi2, . . . , mi8 (each mij contains six bits) corresponding to the inputs to the S-boxes. The 32-bit data on the left side is subjected to reverse permutation of the round function and divided into mo1, mo2, . . . , mo8 (each moj contains four bits) corresponding to the outputs from the S-boxes. Each S-box (initial S-box) stored in the ROM 506 is represented by Sj. Each S-box (deformed S-box) deformed depending on the mask random number is represented by MSj (j=1, 2, . . . , 8).

In correspondence with an input i (six bits), MSj outputs the exclusive OR between moj (four bits) and the output (four bits) from Sj that receives the exclusive OR between i and mij. Such MSj is stored in the RAM 507 as, e.g., a table and supplied to the round function.

When the mask random number 602a is selected by the selection processing 604, the arithmetic unit 503 executes an exclusive OR 605 between the mask random number 602a and the plaintext block 601. The obtained data (64 bits) is subjected to initial permutation 606 and divided into 32-bit data on the left (upper) side and 32-bit data on the right (lower) side. The data are input to a round function 607 using MSj as an S-box. The arrangement of the round function is the same as that shown in FIG. 2 except that Sj changes to MSj (j=1, 2, . . . , 8).

The round function calculation is repeated 16 times. After final permutation 608 is performed, an exclusive OR 609 between the mask random number 602a and the output from the final permutation 608 is executed. A ciphertext block 610 is obtained and output from the input/output unit 501.

The encryption apparatus according to the above-described first embodiment statistically balances bits by using random numbers generated by the random number generator 504 instead of designing mask values containing well-balanced bits in advance. The encryption apparatus of the first embodiment can easily be designed because the bit balance of mask values need not be taken into consideration. Since leakage of mask value information by, e.g., reverse engineering can be prevented, the security can be improved. Since the timing to generate mask random numbers to be used changes in every encryption processing, key information estimation by higher-order DPA can be made difficult.

### MODIFICATION TO FIRST EMBODIMENT

In the first embodiment, the random number generator 504 generates a 1-bit random number as a selection random number. In some implementations, each generated random number has a fixed length, and no 1-bit random number can be generated. In this case, the random number generation processing is time-consuming. In the modification to the first embodiment, a specific bit (e.g., the least significant bit) of a predetermined one (e.g., the mask random number 602a generated first) of two random numbers generated is used as a selection variable. The value of the selection variable is also used as a random number. One of the two mask random numbers generated is selected on the basis of this value. According to this modification, the number of times of random number generation processing can be reduced by one.

### SECOND EMBODIMENT

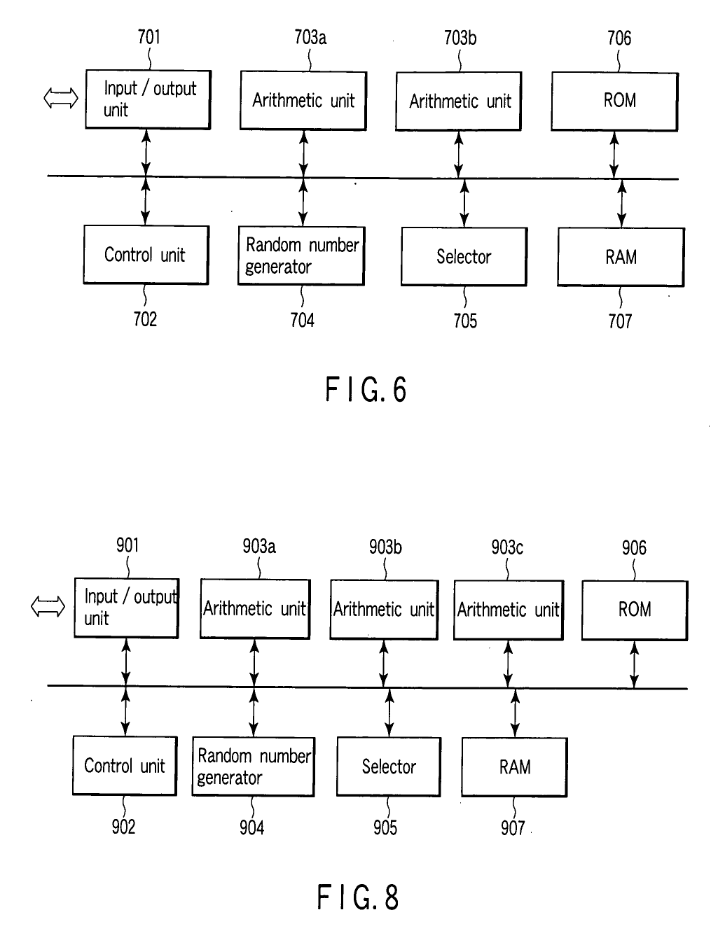

Referring to FIG. 6, the encryption apparatus according to the second embodiment includes an input/output unit 701, control unit 702, arithmetic units 703a and 703b, random number generator 704, selector 705, read only memory (ROM) 706, and random access memory (RAM) 707.

The input/output unit 701 receives, as an input, a plaintext block (64 bits) from the outside and outputs a ciphertext block (64 bits) as a calculation result. The control unit 702 generates a clock signal and controls the operation of the encryption apparatus. The arithmetic units 703a and 703b execute arithmetic processing such as addition and exclusive OR in accordance with an input (instruction and data). The random number generator 704 generates mask random numbers and a selection random number. The selector 705 selects one of the exclusive OR results between the plaintext block and the mask random numbers, which are calculated by the arithmetic units 703a and 703b, and one of two deformed S-boxes which are deformed in correspondence with the two mask random numbers. The ROM 706 stores instruction codes, initial permutation, expansion permutation, S-boxes, permutation using round functions, final permutation, key information, and information necessary for key schedule. The RAM 707 is a memory to save random numbers generated by the random number generator 704, deformed S-boxes, and data obtained in a calculation process.

Even in the second embodiment, the security can further be improved by using the method of Mehdi-Laurent Akkar et al., as in the first embodiment, though a description thereof will be omitted.

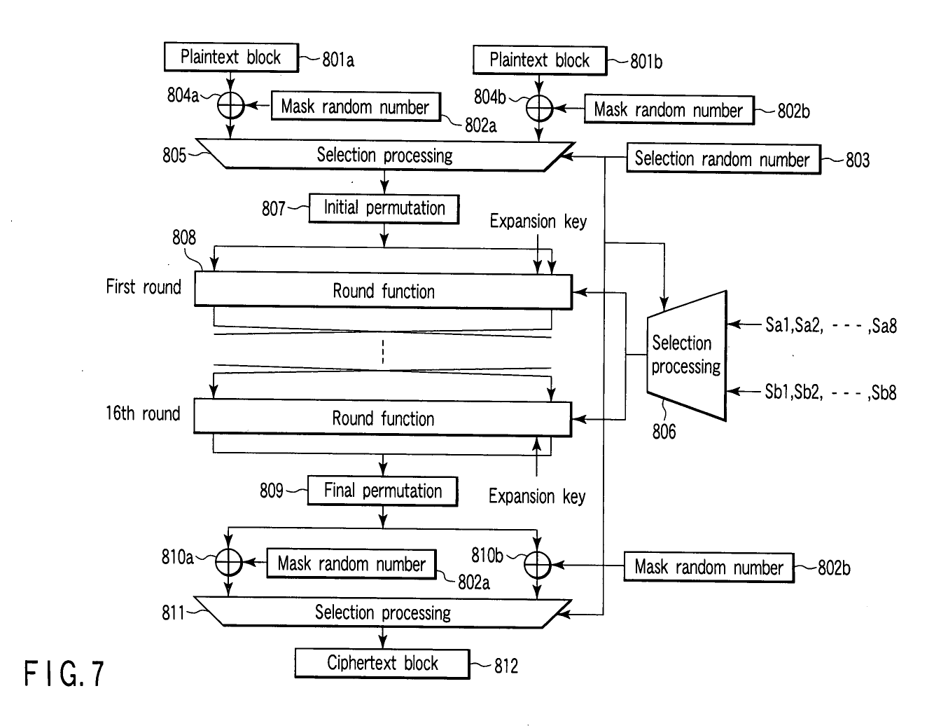

The operation of the encryption apparatus according to the second embodiment will be described with reference to FIG. 7.

When the input/output unit 701 receives a plaintext block (64 bits), the random number generator 704 generates mask random numbers 802a and 802b (each contains 64 bits) and a selection random number 803 (one bit). The arithmetic units 703a and 703b receive, as inputs, the plaintext blocks (plaintext blocks 801a and 801b contain identical data) and the mask random numbers 802a and 802b and execute exclusive ORs 804a and 804b in the same clock cycle, respectively.

In correspondence with the two mask random numbers 802a and 802b, the arithmetic units (converters) 703a and 703b convert S-boxes stored in the ROM 706 into two deformed S-boxes. The conversion rule is the same as in the first embodiment, and a description thereof will be omitted. The obtained two deformed S-boxes, i.e., MSaj and MSbj (j=1, 2, . . . , 8) are stored in the RAM 707 as tables.

On the basis of the selection random number 803, the selector 705 executes selection processing 805 of one of the two data which have undergone mask processing using the mask random numbers. Additionally, on the basis of the selection random number 803, the selector 705 executes selection processing 806 of one set of the deformed S-boxes (MSa1, MSa2, . . . , MSa8) and (MSb1, MSb2, . . . , MSb8) stored in the RAM 707.

When the above processing is ended, the plaintext block (64 bits) which has undergone mask processing and is selected by the selection processing 805 is subjected to initial permutation 807. The processing result is divided into 32-bit data on the left (upper) side and 32-bit data on the right (lower) side and input to a round function 808 to which MSaj or MSbj is supplied as an S-box. The arrangement of the round function is the same as that shown in FIG. 2 except that Sj changes to the deformed S-box selected from MSaj and MSbj (j=1, 2, . . . , 8) by the selection processing 805.

The round function calculation is repeated 16 times. The result is subjected to final permutation 809. The arithmetic units 703a and 703b receive, as inputs, the output from the final permutation 809 (exclusive ORs 810a and 810b receive identical data) and the mask random numbers 802a and 802b and execute the exclusive ORs 810a and 810b in the same clock cycle, respectively. The results are input to the selector 705. The selector 705 executes selection processing 811 of one of the outputs from the exclusive ORs 810a and 810b in accordance with the selection random number 803. A ciphertext block 812 is obtained and output from the input/output unit 701.

The encryption apparatus according to the above-described second embodiment selects one of results obtained by executing mask processing for a plurality of (in this embodiment, two) mask random numbers in parallel instead of selecting a mask random number before mask processing is executed for a plaintext block. With this arrangement, correlation between power consumption and data to be processed in the encryption apparatus is reduced.

The encryption apparatus according to the second embodiment can make it difficult to estimate key information by higher-order DPA using the timing of plaintext block mask processing and the timing of nonlinear operation of encryption processing.

### MODIFICATION TO SECOND EMBODIMENT

Even in the second embodiment, the same modification as in the first embodiment is possible. That is, the number of times of random number generation processing can be reduced by one by using the least significant bit of the mask random number 802a as a selection random number.

### THIRD EMBODIMENT

Referring to FIG. 8, the encryption apparatus according to the third embodiment includes an input/output unit 901, control unit 902, arithmetic units 903a, 903b, and 903c, random number generator 904, selector 905, read only memory (ROM) 906, and random access memory (RAM) 907.

The input/output unit 901 receives, as an input, a plaintext block (64 bits) from the outside and outputs a ciphertext block (64 bits) as a calculation result. The control unit 902 generates a clock signal and controls the operation of the encryption apparatus. The arithmetic units 903a, 903b, and 903c execute arithmetic processing such as addition and exclusive OR in accordance with an input (instruction and data). The random number generator 904 generates a mask random number and a selection random number. The selector 905 selects one of the exclusive OR results between the plaintext block and the mask variables, which are calculated by the arithmetic units 903a, 903b, and 903c, and one of a plurality of (three) deformed S-boxes which are deformed in correspondence with the mask variables. The ROM 906 stores instruction codes, initial permutation, expansion permutation, S-boxes, permutation using round functions, final permutation, key information, information necessary for key schedule, two mask variables (64-bit fixed values), and deformed S-boxes corresponding to the two mask variables. The RAM 907 is a memory to save a random number generated by the random number generator 904, deformed S-boxes, and data obtained in a calculation process.

Even in the third embodiment, the security can further be improved by using the method of Mehdi-Laurent Akkar et al., as in the first embodiment, though a description thereof will be omitted.

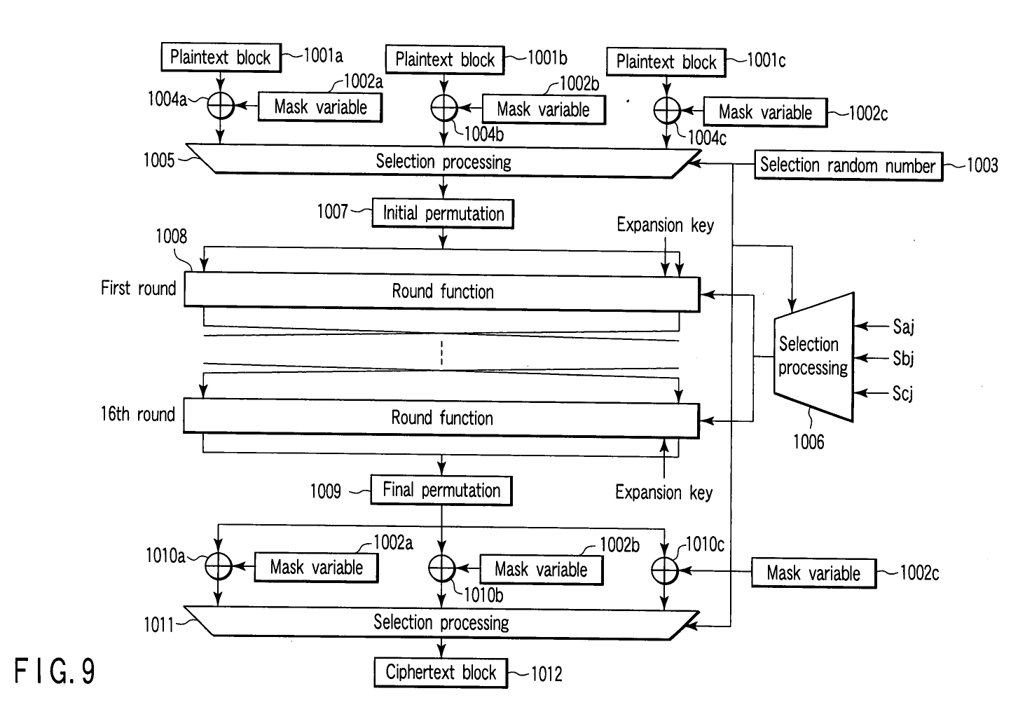

The operation of the encryption apparatus according to the third embodiment will be described with reference to FIG. 9.

In the encryption apparatus of the third embodiment, fixed values are substituted into mask variables 1002a and 1002b in advance and stored in the ROM 906. The mask variables 1002a and 1002b preferably contain reverse bit strings to improve the security. For example, 0101 . . . 01 (64 bits) is stored in the ROM 906 as the mask variable 1002a, and 1010 . . . 10 (64 bits) is stored in the ROM 906 as the mask variable 1002b. Deformed S-boxes (MSa1, MSa2, . . . , MSa8) and (MSb1, MSb2, . . . , MSb8) corresponding to the mask variables are calculated in the same way as in the first embodiment and stored in the ROM 906.

When the input/output unit 901 receives a plaintext block (64 bits), the random number generator 904 generates a mask random number (64 bits) and a selection random number (two bits). The mask random number is substituted into a mask variable 1002c. The arithmetic units 903a, 903b, and 903c receive, as inputs, the plaintext blocks (plaintext blocks 1001a, 1001b, and 1001c contain identical data) and the mask variables 1002a, 1002b, and 1002c and execute exclusive ORs 1004a, 1004b, and 1004c in the same clock cycle, respectively.

In correspondence with the mask random number 1002c, the arithmetic unit 903c converts S-boxes stored in the ROM 906 into deformed S-boxes. The conversion rule is the same as in the first embodiment, and a description thereof will be omitted. Each converted deformed S-box, i.e., MScj (j=1, 2, . . . , 8) is stored in the RAM 907 as a table.

On the basis of a selection random number 1003, the selector 905 executes selection processing 1005 of one of the three data which have undergone mask processing using the mask variables. Additionally, on the basis of the selection random number 1003, the selector 905 executes selection processing 1006 of one set of the deformed S-boxes (MSa1, MSa2, . . . , MSa8), (MSb1, MSb2, . . . , MSb8) and (MSc1, MSc2, . . . , MSc8) stored in the ROM 906 and RAM 907.

When-the above processing is ended, the plaintext block (64 bits) which has undergone mask processing and is selected by the selection processing 1005 is subjected to initial permutation 1007. The result is divided into 32-bit data on the left (upper) side and 32-bit data on the right (lower) side and input to a round function 1008 to which MSaj, MSbj, or MScj is supplied as an S-box. The arrangement of the round function is the same as that shown in FIG. 2 except that Sj changes to the deformed S-box selected from MSaj, MSbj, and MScj (j=1, 2, . . . , 8) by the selection processing 1005.

The round function calculation is repeated 16 times. The result is subjected to final permutation 1009. The arithmetic units 903a, 903b, and 903c receive, as inputs, the output from the final permutation 1009 (exclusive ORs 1010a, 1010b, and 1010c receive identical data) and the mask variables 1002a, 1002b, and 1002c and execute the exclusive ORs 1010a, 1010b, and 1010c in the same clock cycle, respectively. The selector 905 executes selection processing 1011 of one of the outputs from the exclusive ORs 1010a, 1010b, and 1010c in accordance with the selection random number 1003. A ciphertext block 1020 is obtained and output from the input/output unit 901.

The encryption apparatus according to the above-described third embodiment generates only one random number as a mask random number. The same processing as that of the encryption apparatus of the second embodiment is executed by using a total of three mask variables, i.e., the random number and two mask values fixed in advance.

### MODIFICATION TO THIRD EMBODIMENT

Even in the third embodiment, the same modification as in the first embodiment is possible. In the modification to the third embodiment, the two lower bits of the mask variable 1002c are used as a selection variable. When the two lower bits are 00, the mask variable 1002a is used. When the two lower bits are 01, the mask variable 1002b is used. When the two lower bits are 10 or 11, the mask variable 1002c is used. With this arrangement, the number of times of random number generation processing can be reduced by one.

### FOURTH EMBODIMENT

In the fourth embodiment, the present invention is applied to advanced encryption standard (AES). However, the present invention may be applied to DES.

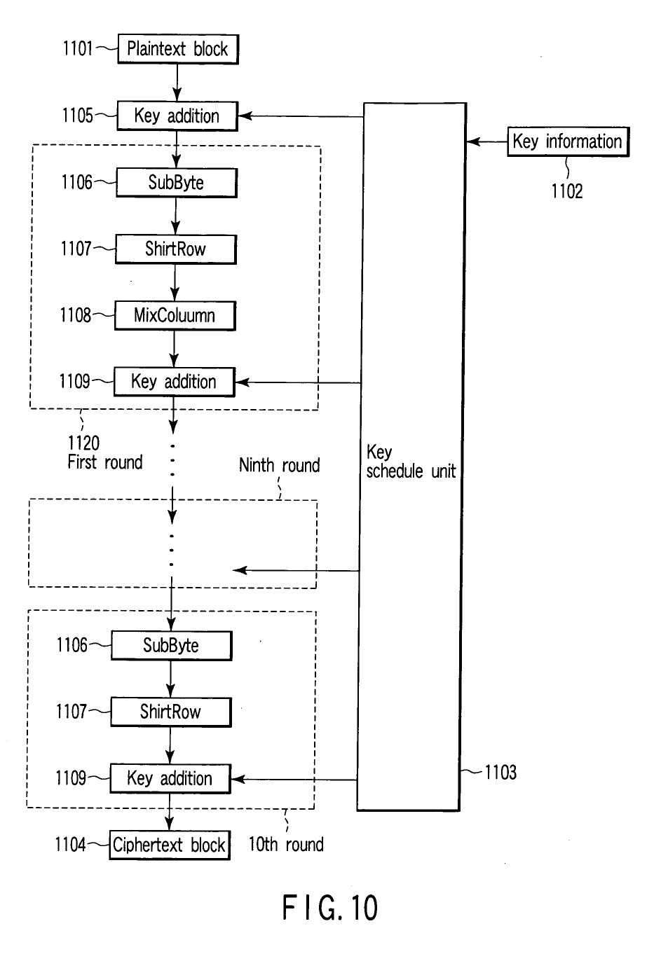

Referring to FIG. 10, a key schedule unit 1103 calculates an encryption key from key information 1102 secretly held in an encryption apparatus. A plaintext block 1101 is shuffled in each round function by using the encryption key. As a result, a ciphertext block 1104 is calculated. More specifically, the plaintext block 1101 is subjected to key addition 1105 using the encryption key calculated by the key schedule unit and input to a round function 1120. The data input to the round function 1120 undergoes SubByte 1106, ShiftRow 1107, MixColumn 1108, and key addition 1109 in this order and is then input to the next round function. Such a round function is repeated nine times. Then, SubByte 1110, ShiftRow 1111, and key addition 1112 are executed. The encryption processing is thus complete so that the ciphertext block 1104 is obtained. The SubByte 1110, ShiftRow 1111, and key addition 1112 are called a 10th round function.

The SubByte, ShiftRow, and MixColumn express 128-bit data as 16 8-bit data blocks and process them.

The SubByte executes the following processing for each of the 16 data blocks. First, the 8-bit data of each data block is regarded as a number I of an eighth-order extension field GF(2⁸) of GF(2) with an irreducible polynomial given by:
b(x)=x⁸+x⁴+x³+x+1
The inverse of I is calculated by:
J=I⁻¹ (where 0⁻¹ is defined as 0)
Next, J that is expressed as the inverse of I is regarded as 8-bit data J₁J₂ . . . J₈ (Jᵢ is 1 bit). For i=0, 1, . . . , 7, J′ᵢ=Jᵢ(+)J_{i+4mod8}(+)J_{i+5mod8}(+)J_{i+6mod8}(+)J_{i+7mod8}(+)Cᵢ is calculated. In this case, (+) represents an exclusive OR, and Cᵢ is a bit where (C₇,C₆,C₅,C₄,C₃,C₂,C₁,C₀)=(0,1,1,0,0,0,1,1). A method of calculating J′=J′₇J′₆J′₅J′₄J′₃J′₂J′₁J′₀ from the 8-bit data j is called affine transformation of SubByte and will be referred to as J′=A(J). That is, when SubByte is executed for each data block I, A(I⁻¹) is output.

The SubByte is implemented by a method of calculating the above-described J=I⁻¹ and A(I⁻¹) by using adding and multiplying circuits or a method of preparing a table that outputs A(I⁻¹) in correspondence with input I. The former method requires a large circuit scale but can reduce the memory capacity.

The ShiftRow and MixColumn arrange 16 data blocks in a 4×4 matrix and execute transformation of each block.

The ShiftRow executes cyclic permutation of a predetermined size in each row of the matrix. The MixColumn executes predetermined matrix transformation in each column of the matrix. Matrix transformation is implemented by a calculation method using adding and multiplying circuits or a calculation method using only an adding circuit by expanding the operation.

The key addition calculates the exclusive OR of 128-bit data and the 128-bit expansion key calculated by the key schedule unit.

In the fourth embodiment, assume that a multiplying circuit and an adding circuit are provided to execute the above-described SubByte and MixColumn.

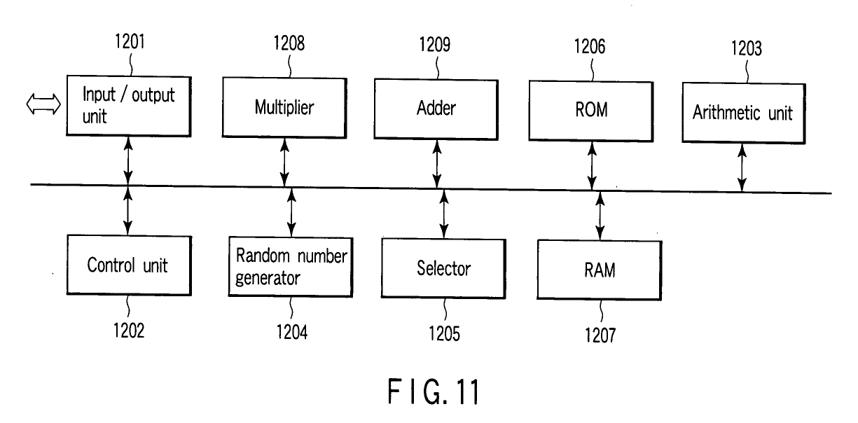

Referring to FIG. 11, the encryption apparatus according to the fourth embodiment includes an input/output unit 1201, control unit 1202, arithmetic unit 1203, random number generator 1204, selector 1205, read only memory (ROM) 1206, random access memory (RAM) 1207, multiplier 1208, and adder 1209.

The input/output unit 1201 receives, as an input, a plaintext block (128 bits) from the outside and outputs a ciphertext block (128 bits) as a calculation result. The control unit 1202 generates a clock signal and controls the operation of the encryption apparatus. The arithmetic unit 1203 executes arithmetic processing such as addition and exclusive OR in accordance with an input (instruction and data). The multiplier 1208 and adder 1209 are circuits dedicated to multiplication and addition and therefore can execute multiplication and addition more efficiently than the arithmetic unit 1203. In the fourth embodiment, the multiplier 1208 and adder 1209 are used for mask processing and calculation of SubByte and MixColumn.

The random number generator 1204 generates two mask random numbers and one selection random number. The selector 1205 selects one of processing results of a plaintext block and mask random numbers, which are calculated by the multiplier 1208 and adder 1209, and also selects one of two sets of values which are calculated in correspondence with the mask random numbers and to be used in the SubByte. The values used in the SubByte will be described later in detail.

The ROM 1206 stores instruction codes, SubByte, ShiftRow, MixColumn, key information, and information necessary for key schedule. The RAM 1207 is a memory to save random numbers generated by the random number generator 1204 and data obtained in a calculation process.

The fourth embodiment can also improve the security by using different masks in rounds, as in the first embodiment, though a description thereof will be omitted.

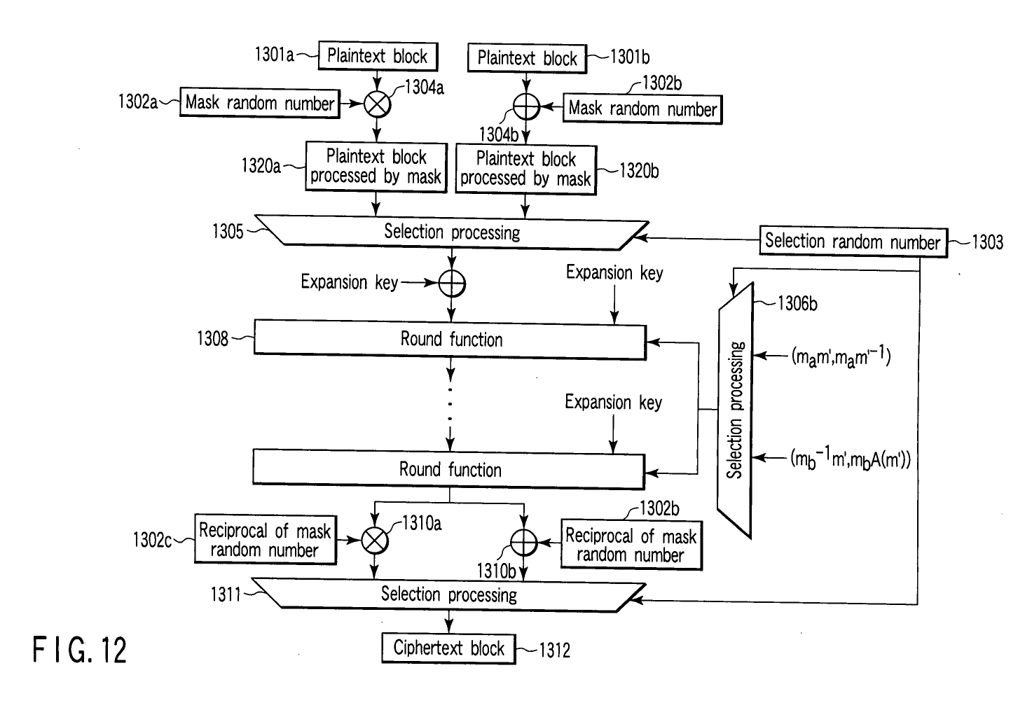

The operation of the encryption apparatus according to the fourth embodiment will be described next with reference to FIG. 12.

When the input/output unit 1201 receives a plaintext block (128 bits), the random number generator 1204 generates mask random numbers mₐ 1302a and m_{b} 1302b (each contains 128 bits), a selection random number 1303 (one bit), and a SubByte mask random number m′ (128 bits).

The multiplier 1208 receives, as inputs, a plaintext block 1301a and the mask random number mₐ 1302a. The adder 1209 receives, as inputs, a plaintext block 1301b (plaintext blocks 1301a and 1301b contain identical data) and the mask random number m_{b} 1302b. Regarding each 128-bit data as 16 8-bit data blocks, the multiplier 1208 and adder 1209 execute multiplication 1304a and addition 1304b, respectively, in the extension field GF(2⁸) in the same clock cycle, thereby executing mask processing.

The arithmetic unit 1203 calculates inverse elements mₐ=(mₐ₁₅, ma₁₄, . . . mₐ₀), m_{b}=(m_{b15}, m_{b14}, . . . , m_{b0}), m′=(m′₁₅, m′₁₄, . . . , m′₀) of the mask random numbers mₐ⁻¹=(mₐ₁₅⁻¹, mₐ₁₄⁻¹, . . . , mₐ₀⁻¹), m_{b}⁻¹=(m_{b15}⁻¹, m_{b14}⁻¹, . . . , m_{b0}⁻¹), m′⁻¹=(m′₁₅⁻¹, m′₁₄⁻¹, . . . , m′₀⁻¹) and the affine transformation A(m′ᵢ) of SubByte. The calculation result is used to calculate data to be used in the SubByte calculated by the multiplier 1208. Note that mₐᵢ, m_{bi}, m′ᵢ(i=0, 1, 2, . . . , 15) represents 16 data blocks obtained by dividing mₐ, m_{b}, and m′ into 8-bit data.

The multiplier 1208 calculates mₐ⁻¹m′=(mₐ₁₅⁻¹m′₁₅, ma₁₄⁻¹m′₁₄, . . . , mₐ₀⁻¹m′₀), mₐA(m′)=mₐ₁₅A(m′₁₅), mₐ₁₄A(m′₁₄), . . . , mₐ₀A(m′₀), m_{b}m′=(m_{b15}m′₁₅, m_{b14}m′₁₄, . . . , m_{b0}m′₀), m_{b}m′⁻¹=(m_{b15}m′₁₅⁻¹, m_{b14}m′₁₄⁻¹, . . . , m_{b0}m′₀⁻¹) as data to be used in the SubByte. The RAM 1207 stores mₐ⁻¹ and mₐ⁻¹m′, mₐA(m′) and m_{b}m′, m_{b}m′⁻¹. These mₐ⁻¹m′, mₐA(m′) and m_{b}m′, m_{b}m′⁻¹ are the above-described two sets of values selected by the selector.

The selector 1205 executes, on the basis of the selection random number 1303, selection processing 1305 of one of two plaintext blocks 1320a and 1320b which have undergone mask processing by the multiplier 1208 and adder 1209. The selector 1205 also executes, on the basis of the selection random number 1303, selection processing 1306 of one of two sets of values mₐ⁻¹m′, mₐA(m′) and m_{b}m′, m_{b}m′⁻¹ stored in the RAM.

When the above-described processing is complete, the plaintext block (128 bits) after mask processing which is selected by the selection processing 1305 is added the expansion key and input to a round function.

If a plaintext block 1308a which has undergone mask processing by multiplication is selected in accordance with the selection random number, processing is changed such that all the key addition, SubByte, ShiftRow, and MixColumn input/output data based on the plaintext block 1320a that has undergone mask processing by multiplication. On the other hand, if a plaintext block 1308b which has undergone mask processing by addition is selected, processing is changed such that all the functions input/output data based on the plaintext block 1320b that has undergone mask processing by addition.

When Plaintext Block 1320a that has Undergone Mask Processing by Multiplication is Selected

Key addition and processing in each round function when the plaintext block 1320a that has undergone mask processing by multiplication is selected by the selection processing 1305 will be examined.

Data input to each processing is represented by d=(d₁₅, d₁₄, . . . , d₀). The mask mₐ is given by mₐ=(mₐ₁₅, mₐ₁₄, . . . , mₐ₀). Data dmₐ=(d₁₅mₐ₁₅, d₁₄mₐ₁₄, . . . , d₀mₐ₀) that has undergone mask processing by multiplication of GF(2⁸) will be considered.

Key addition is a function to calculate the exclusive OR of data d and an expansion key k. If the data d has undergone mask processing by the multiplication 1304a, (d (+) k)mₐ must be calculated from dmₐ and k.

The expansion key k is expressed by k=(k₁₅, k₁₄, . . . , k₀). Note that kᵢ (i=0, . . . , 15) represents 16 data blocks obtained by dividing the data into 8-bit data. At this time, when kmₐ=(k₁₅mₐ₁₅, k₁₄mₐ₁₄, . . . , k₀mₐ₀) is calculated, and key addition is processed by addition of dmₐ and kmₐ in GF(2⁸), (d (+) k)mₐ is obtained.

Addition of GF(2⁸) is calculated by adding mod2 of each coefficient when expressing the 8-bit data by GF(2⁸) and is equivalent to the exclusive OR. Hence, dmₐ+kmₐ=(d+k)mₐ equals (d (+) k)mₐ.

The ShiftRow will be considered. The ShiftRow executes substitution by regarding the divided 8-bit data block as one unit. The mask random numbers mₐ and m_{b} are also substituted in blocks of 8 bits.

The MixColumn will be examined. The MixColumn executes matrix transformation for the received data d by using the divided 8-bit data block. In matrix transformation, the product of each component of the transformation matrix and the mask data is calculated such that output data after MixColumn becomes data processed by the mask mₐ.

For example, of (d′₁₅, d′₁₄, . . . , d′₀) obtained by inputting (d₁₅, d₁₄, . . . , d₀) to MixColumn, d′₁₅ can be obtained by a product (0x02, 0x03, 0x01, 0x01)(d₁₅, d₁₄, d₁₃, d₁₂)T (T represents transposition).

When a product (dm_{a,15}, dm_{a,14}, dm_{a,13}, dm_{a,12})T is calculated by using (0x02, 0x03*m_{a,14-1}l*mₐ₁₅, 0x01*m_{a,13}⁻¹*m_{a,15}, 0x01*m_{a,12}⁻¹*mₐ₁₅) in place of 0x02, 0x03, 0x01, 0x01, the 15th block of the output of MixColumn upon receiving the data dmₐ that has undergone the mask processing can be obtained. The product of the remaining blocks of MixColumn and the mask can be calculated in the same way.

Processing of SubByte will be considered finally. The SubByte is a function that outputs (A(d₁₅⁻¹) A(d₁₄⁻¹), . . . , A(d₀⁻¹)) in correspondence with the input data d=(d₁₅, d₁₄, . . . , d₀). If the data dmₐ processed by the multiplication mask is input, (A(d₁₅⁻¹)m_{a,15}, A(d₁₄⁻¹)m_{a,14}, . . . , A(d₀⁻¹)m_{a,0}) must be calculated from dmₐ in the following way.

First, the arithmetic unit 1203 calculates (dmₐ)⁻¹=(d₁₅⁻¹m_{a,15}⁻¹, d₁₄⁻¹m_{a,14}⁻¹, . . . , d₀⁻¹m_{a,0}⁻¹). Next, the arithmetic unit adds mₐ⁻¹m′ to (dmₐ)⁻¹ and calculates (d⁻¹+m′)mₐ⁻¹=((d₁₅⁻¹+m′₁₅)m_{a,15}⁻¹, (d₁₄⁻¹+m′₁₄)m_{a,14}⁻¹, . . . , (d₀⁻¹+m′₀)m_{a,0}⁻¹). d⁻¹+m′=(d₁₅⁻¹+m′₁₅, d₁₄⁻¹+m′₁₄, . . . , d₀⁻¹+m′₀) is calculated by multiplying mₐ. When affine transformation A(·) is applied to each block, (A(d₁₅⁻¹)+A(m′₁₅), A(d₁₄⁻¹)+A(m′₁₄), . . . , A(d₀⁻¹)+A(m′₀)) is obtained. This value is multiplied by mₐ to calculate ((A(d₁₅⁻¹)m_{a,15}+A(m′₁₅)m_{a,15}, A(d₁₄⁻¹)m_{a,14}+A(m′₁₄)m_{a,14}, . . . , A(d₀⁻¹)m_{a,0}+A(m′₀)m_{a,0}). By adding mₐA(m′), (A(d₁₅⁻¹)m_{a,15}, A(d₁₄⁻¹)m_{a,14}, . . . , A(d₀⁻¹)m_{a,0}) can be calculated.

When Plaintext Block 1320b that has Undergone Mask Processing by Addition is Selected

Key addition and processing in each round function when the plaintext block 1320b that has undergone mask processing by addition is selected by the selection processing 1305 will be examined.

Data input to each processing is represented by d=(d₁₅, d₁₄, . . . , d₀). The mask is given by m_{b}=(m_{b15}, m_{b14}, . . . , m_{b0}). If input data has undergone mask processing by addition of GF(2⁸), data input to each processing is represented by d+m_{b}=(d₁₅+m_{b15}, d₁₄+m_{b14}, . . . , d₀+m_{b0}). Key addition and processing in each round function upon receiving d+m_{b} will be examined below.

Key addition is a function to calculate the exclusive OR of the data d and the expansion key k. If the data d has undergone mask processing by the addition 1304b, (d (+) k)+m_{b} must be calculated from d+m_{b} and k. As described above, addition of GF(2⁸) is calculated by adding mod2 of each coefficient when expressing the 8-bit data by GF(2⁸) and is equivalent to the exclusive OR. Hence, when (d+m_{b})+k=((d₁₅+m_{b,15})+k₁₅, (d₁₄+m_{b,14})+k₁₄, . . . , (d₀+m_{b,0})+k₀) is calculated, (d (+) k)+m_{b} can be obtained.

The ShiftRow will be considered. As in mask processing by multiplication, the ShiftRow executes substitution by regarding the divided 8-bit data block as one unit. The data mₐ and m_{b} are also substituted in blocks of 8 bits.

The MixColumn will be examined. As described above, the MixColumn executes matrix transformation for by using the divided 8-bit data block. When data that has undergone mask processing by addition is input, the difference of the product of each component of the transformation matrix and the mask data is calculated, thereby obtaining data processed by the mask mₐ as the output data as a result of MixColumn.

For example, when m_{b,15}−0x02*m_{b,15}−0x03*m_{b,14}−0x01*m_{b,13}−0x01*m_{b,12} is added to a product (0x02, 0x03, 0x01, 0x01)(d₁₅+m_{b,15}, d₁₄+m_{b14}, d₁₃+m_{b,13}, d₁₂+m_{b,12})T, the output of MixColumn upon receiving the data d+m_{b} that has undergone mask processing can be obtained. The sum of the remaining blocks of MixColumn and the mask can be calculated in the same way.

Processing of SubByte will be considered finally. The SubByte is a function that outputs (A(d₁₅⁻¹), A(d₁₄⁻¹), . . . , A(d₀⁻¹)) in correspondence with the input data d=(d₁₅, d₁₄, . . . , d₀). If the data d+m_{b} processed by the addition mask is input, (A(d₁₅⁻¹)+m_{b,15}, A(d₁₄⁻¹)+m_{b,14}, . . . , A(d₀⁻¹)+m_{b,0}) must be calculated from d+m_{b} in the following way.

First, m′ is multiplied by d+m_{b} to calculate (d+m_{b})m′=((d₁₅+m_{b,15})m′₁₅, (d₁₄+m_{b,14})m′₁₄ . . . , (d₀+m_{b,0})m′₀). dm′=(d₁₅m′₁₅, d₁₄m′₁₄, . . . , d₀m′₀) is calculated by adding m_{b}m′ to obtained data. An inverse element (dm′)⁻¹=(d₁₅⁻¹m′₁₅⁻¹, d₁₄⁻¹m′₁₄⁻¹, . . . , d₀⁻¹m′₀⁻¹) is calculated.

Next, m_{b}m′⁻¹ is added to (dm′)⁻¹ to calculate (d⁻¹+m_{b})m′⁻¹=((d₁₅⁻¹+m_{b,15})m′₁₅⁻¹, (d₁₄⁻¹+m_{b,14})m′₁₄⁻¹, . . . , (d₀⁻¹+m_{b,0})m′₀⁻¹). d⁻¹+m_{b}=(d₁₅⁻¹+m_{b,15}, d₁₄⁻¹+m_{b,14}, . . . , d₀⁻¹+m_{b,0}) is calculated by multiplying m′. When affine transformation A(·) is applied to this value, (A(d₁₅⁻¹)+A(m_{b,15}), A(d₁₄⁻¹)+A(m_{b,14}), . . . , A(d₀⁻¹)+A(m_{b,0})) is obtained.

Finally, A(m_{b,0})+m_{b,o} is added to obtain (A(d₁₅⁻¹)+m_{b,15}, A(d₁₄⁻¹)+m_{b,14}, . . . , A(d₀⁻¹)+m_{b,0}) The final addition can be done together with the key addition.

As described above, calculation of the round function is repeated 10 times in accordance with the plaintext block selected by the selection processing 1305. Then, the multiplier 1208 and adder 1209 receive, as the inputs, the output from the 10th round function, a reciprocal mₐ⁻¹ 1302c of the mask random number, and the mask random number m_{b} 1302b and execute multiplication 1310a and addition 1310b in the same clock cycle. The results are input to the selector 1205.

The selector 1205 executes, on the basis of the selection random number 1303, selection processing 1311 of one of the outputs of the multiplication 1310a and addition 1310b. With this processing, a ciphertext block 1312 is obtained and output from the input/output unit 1201.

The above-described encryption apparatus according to the fourth embodiment selects one of plaintext blocks which have undergone mask processing by a plurality of mask calculation methods, thereby reducing the correlation between power consumption and data processed in the encryption apparatus. This can make it difficult to estimate key information using power consumption as in DPA or higher-order DPA. In the fourth embodiment, to prevent selection from being specified on the basis of the order or SubByte processing or the calculation time, the calculation order and calculation time must be uniformed by adding dummy processing.

In the fourth embodiment, any increase in circuit scale can be prevented by using multiplying and adding circuits that are held to execute SubByte and MixColumn in different operations (multiplication and addition) as two mask processes.

### MODIFICATION TO FOURTH EMBODIMENT

The fourth embodiment can also be modified as in the first embodiment. That is, the number of times of random number generation processing can be reduced by one by using the least significant bit of the mask random number mₐ 1302a as a selection variable.

In addition, when identical random numbers are used as mₐ and m_{b}, the number of times of random number generation processing can be reduced by one.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An encryption apparatus, comprising:
a random number generator which generates a plurality of random numbers;
a selector which selects one mask random number from the plurality of random numbers at random;
a mask processing unit which executes mask processing of a plaintext block by using the mask random number selected by the selector;
a storage unit which stores a first table representing an initial S-box;
a converter which converts the first table into a second table representing a deformed S-box on the basis of the mask random number selected by the selector; and
an encryption unit which generates a ciphertext block by shuffling the mask-processed plaintext block using the second table.

2. The apparatus according to claim 1, wherein the selector selects the mask random number in accordance with a specific bit of one of the plurality of random numbers generated by the random number generator.

3. An encryption apparatus, comprising:
a random number generator which generates a plurality of random numbers;
a plurality of mask processing units which execute mask processing of a plaintext block by using the plurality of random numbers to obtain a plurality of mask-processed plaintext blocks;
a storage unit which stores a first table representing an initial S-box;
a converter which converts the first table into a plurality of deformed tables representing deformed S-boxes on the basis of the plurality of random numbers;
a selector which selects one of the mask-processed plaintext blocks and selects one of the deformed tables in accordance with the selection of one of the mask-processed plaintext blocks; and
an encryption unit which generates a ciphertext block by shuffling the selected one of the mask-processed plaintext blocks using the selected one of the deformed tables.

4. The apparatus according to claim 3, wherein the selector selects one of the mask-processed plaintext blocks in accordance with a specific bit of one of the plurality of random numbers generated by the random number generator.

5. The apparatus according to claim 3, wherein the mask processing units execute the mask processing in accordance with an identical clock.

6. An encryption apparatus, comprising:
a first storage unit which stores a first fixed value and a second fixed value;
a second storage unit which stores a table representing an initial S-box;
a third storage unit which stores a first table representing a first deformed S-box obtained by converting the initial S-box on the basis of the first fixed value and a second table representing a second deformed S-box obtained by converting the initial S-box on the basis of the second fixed value;
a random number generator which generates a random number;
a first mask processing unit which executes mask processing of a plaintext block by using the first fixed value to obtain a first mask-processed plaintext block;
a second mask processing unit which executes mask processing of the plaintext block by using the second fixed value to obtain a second mask-processed plaintext block;
a third mask processing unit which executes mask processing of the plaintext block by using the random number to obtain a third mask-processed plaintext block;
a converter which converts the table representing the initial S-box into a third table representing a third deformed S-box on the basis of the random number;
a selector which selects one of the first mask-processed plaintext block, the second mask-processed plaintext block, and the third mask-processed plaintext block at random and selects one of the first table, the second table, and the third table in accordance with the selection of one of the first mask-processed plaintext block, the second mask-processed plaintext block, and the third mask-processed plaintext block; and
an encryption unit which generates a ciphertext block by shuffling the selected one of the first mask-processed plaintext block, the second mask-processed plaintext block, and the third mask-processed plaintext block using the selected one of the first table, the second table, and the third table.

7. The apparatus according to claim 6, wherein the selector selects one of the first mask-processed plaintext block, the second mask-processed plaintext block, and the third mask-processed plaintext block in accordance with some bits of the random number.

8. An encryption apparatus, comprising:
a random number generator which generates a first random number, a second random number, and a third random number;
a first mask processing unit which executes mask processing of a plaintext block by using the first random number to obtain a first mask-processed plaintext block;
a second mask processing unit which executes mask processing of the plaintext block by using the second random number to obtain a second mask-processed plaintext block;
a calculation unit which calculates a first data on the basis of the first random number and the third random number, and calculates a second data on the basis of the second random number and the third random number;
a selector which selects one of the first mask-processed plaintext block and the second mask-processed plaintext block at random and selects one of the first data and the second data in accordance with the selection of one of the first mask-processed plaintext block and the second mask-processed plaintext block; and
an encryption unit which generates a ciphertext block by shuffling the selected one of the first mask-processed plaintext block and the second mask-processed plaintext block using the selected one of the first data and the second data.

9. The apparatus according to claim 8, wherein the random number generator generates the first random number and the second number in common.

10. The apparatus according to claim 8, wherein the selector selects one of the first mask-processed plaintext block and the second mask-processed plaintext block in accordance with a specific bit of one of the first random number, the second random number, and the third random number.

11. The apparatus according to claim 8, wherein the first mask processing unit and the second mask processing unit execute the mask processing in accordance with an identical clock.

12. An encryption method, comprising:
generating a plurality of random numbers;
selecting one mask random number from the plurality of random numbers at random;
executing mask processing of a plaintext block by using the selected mask random number;
storing a first table representing an initial S-box;
converting the first table into a second table representing a deformed S-box on the basis of the selected mask random number; and
generating a ciphertext block by shuffling the mask-processed plaintext block using the second table.

13. An encryption method, comprising:
generating a plurality of random numbers;
executing mask processing of a plaintext block by using the plurality of random numbers to obtain a plurality of mask-processed plaintext blocks;
storing a first table representing an initial S-box;
converting the first table into a plurality of deformed tables representing deformed S-boxes on the basis of the plurality of random numbers;
selecting one of the mask-processed plaintext blocks and selecting one of the deformed tables in accordance with the selection of one of the mask-processed plaintext blocks; and
generating a ciphertext block by shuffling the selected one of the mask-processed plaintext blocks using the selected one of the deformed tables.

14. An encryption method, comprising:
storing a first fixed value and a second fixed value;
storing a table representing an initial S-box;
storing a first table representing a first deformed S-box obtained by converting the initial S-box on the basis of the first fixed value and a second table representing a second deformed S-box obtained by converting the initial S-box on the basis of the second fixed value;
generating a random number;
executing mask processing of a plaintext block by using the first fixed value to obtain a first mask-processed plaintext block;
executing mask processing of the plaintext block by using the second fixed value to obtain a second mask-processed plaintext block;
executing mask processing of the plaintext block by using the random number to obtain a third mask-processed plaintext block;
converting the table representing the initial S-box into a third table representing a third deformed S-box on the basis of the random number;
selecting one of the first mask-processed plaintext block, the second mask-processed plaintext block, and the third mask-processed plaintext block at random and selecting one of the first table, the second table, and the third table in accordance with the selection of one of the first mask-processed plaintext block, the second mask-processed plaintext block, and the third mask-processed plaintext block; and
generating a ciphertext block by shuffling the selected one of the first mask-processed plaintext block, the second mask-processed plaintext block, and the third mask-processed plaintext block using the selected one of the first table, the second table, and the third table.

15. An encryption method, comprising:
generating a first random number, a second random number, and a third random number;
executing mask processing of a plaintext block by using the first random number to obtain a first mask-processed plaintext block;
executing mask processing of the plaintext block by using the second random number to obtain a second mask-processed plaintext block;
calculating a first data on the basis of the first random number and the third random number, and calculating a second data on the basis of the second random number and the third random number;
selecting one of the first mask-processed plaintext block and the second mask-processed plaintext block at random and selecting one of the first data and the second data in accordance with the selection of one of the first mask-processed plaintext block and the second mask-processed plaintext block; and
generating a ciphertext block by shuffling the selected one of the first mask-processed plaintext block and the second mask-processed plaintext block using the selected one of the first data and the second data.

16. An encryption program stored in a computer-readable medium, the program comprising:
means for instructing a compute to generate a plurality of random numbers;
means for instructing the computer to select one mask random number from the plurality of random numbers at random;
means for instructing the computer to execute mask processing of a plaintext block by using the selected mask random number;
means for instructing the computer to store a first table representing an initial S-box;
means for instructing the computer to convert the first table into a second table representing a deformed S-box on the basis of the selected mask random number; and
means for instructing the computer to generate a ciphertext block by shuffling the mask-processed plaintext block using the second table.

17. An encryption program stored in a computer-readable medium, the program comprising:
means for instructing a computer to generate a plurality of random numbers;
means for instructing the computer to execute mask processing of a plaintext block by using the plurality of random numbers to obtain a plurality of mask-processed plaintext blocks;
means for instructing the computer to store a first table representing an initial S-box;
means for instructing the computer to convert the first table into a plurality of deformed tables representing deformed S-boxes on the basis of the plurality of random numbers;
means for instructing the computer to select one of the mask-processed plaintext blocks and select one of the deformed tables in accordance with the selection of one of the mask-processed plaintext blocks; and
means for instructing the computer to generate a ciphertext block by shuffling the selected one of the mask-processed plaintext blocks using the selected one of the deformed tables.

18. An encryption program stored in a computer-readable medium, the program comprising:
means for instructing a computer to store a first fixed value and a second fixed value;
means for instructing the computer to store a table representing an initial S-box;
means for instructing the computer to store a first table representing a first deformed S-box obtained by converting the initial S-box on the basis of the first fixed value and a second table representing a second deformed S-box obtained by converting the initial S-box on the basis of the second fixed value;
means for instructing the computer to generate a random number;
means for instructing the computer to execute mask processing of a plaintext block by using the first fixed value to obtain a first mask-processed plaintext block;
means for instructing the computer to execute mask processing of the plaintext block by using the second fixed value to obtain a second mask-processed plaintext block;
means for instructing the computer to execute mask processing of the plaintext block by using the random number to obtain a third mask-processed plaintext block;
means for instructing the computer to convert the table representing the initial S-box into a third table representing a third deformed S-box on the basis of the random number;
means for instructing the computer to select one of the first mask-processed plaintext block, the second mask-processed plaintext block, and the third mask-processed plaintext block at random and select one of the first table, the second table, and the third table in accordance with the selection of one of the first mask-processed plaintext block, the second mask-processed plaintext block, and the third mask-processed plaintext block; and
means for instructing the computer to generate a ciphertext block by shuffling the selected one of the first mask-processed plaintext block, the second mask-processed plaintext block, and the third mask-processed plaintext block using the selected one of the first table, the second table, and the third table.

19. An encryption program stored in a computer-readable medium, the program comprising:
means for instructing a computer to generate a first random number, a second random number, and a third random number;
means for instructing the computer to execute mask processing of a plaintext block by using the first random number to obtain a first mask-processed plaintext block;
means for instructing the computer to execute mask processing of the plaintext block by using the second random number to obtain a second mask-processed plaintext block;
means for instructing the computer to calculate a first data on the basis of the first random number and the third random number, and calculate a second data on the basis of the second random number and the third random number;
means for instructing the computer to select one of the first mask-processed plaintext block and the second mask-processed plaintext block at random and select one of the first data and the second data in accordance with the selection of one of the first mask-processed plaintext block and the second mask-processed plaintext block; and
means for instructing the computer to generate a ciphertext block by shuffling the selected one of the first mask-processed plaintext block and the second mask-processed plaintext block using the selected one of the first data and the second data.
